(19) United States
(12) Patent Application Publication
(10) Pub. No.: US 2005/0271961 A1
(43) Pub. Date: Dec. 8, 2005

(54) Substrate and near infrared absorbing toner

(76) Inventors: Thomas A. Jadwin, Rochester, NY (US); Raymond Hardaway, Rochester, NY (US); Thomas J. Foster, Geneseo, NY (US)

Correspondence Address: Paul A. Leipold;Patent Legal Staff, Eastman Kodak Company, 343 State Street, Rochester, NY, 14650-2201, US

(21) Appl. No.: 11/072,780

(22) Filed: Mar. 4, 2005

Related U.S. Application Data
(60) Provisional application No. 60/550,583, filed on Mar. 5, 2004.

(51) Int. Cl. G03G 9/00

(52) U.S. Cl. 430/109.1

(57) ABSTRACT

A paper having toner fixed on its surface, with the toner including a near infrared absorbing dye. The toner-paper absorbance difference is about 0.2 or less at 450 nm, 550 nm, and 650 nm, and about 0.1 or greater at 935 nm.

### CROSS-REFERENCE TO RELATED APPLICATION

Reference is made to the co-pending, commonly assigned, U.S. Provisional Patent Application Ser. No. 60/550,583 filed on Mar. 5, 2004, entitled: SUBSTRATE AND NEAR INFRARED ABSORBING TONER, the disclosure of which is incorporated herein by reference.

### BACKGROUND OF THE INVENTION

1. Field of the Invention

The present invention relates to a toner bearing substrate, where the toner includes a suitable colorant.

2. Description of Background and Other Information

Toners incorporating near infrared absorbing (NIR) colorants are used for purposes such as document authentication, reproduction prevention, tamper protection, and security encoding.

U.S. Pat. No. 5,208,630 discloses encapsulated toners that include infrared absorbing components. The particular infrared absorbing components disclosed are phthalocyanines.

Japanese Patent Publication No. 01-187570 discloses effecting density control with a toner that includes a compound which does not practically show spectral absorption in the visible light range on the electromagnetic spectrum, but has a definite spectral absorption peak in the near infrared range. The indicated compound does not practically show spectral absorption in the 400 nm-700 nm wavelength range, but has a spectral absorption peak at +700 nm, so that the toner can show spectral absorption in the 700 nm-1,000 nm range.

Japanese Patent Publication No. 2001-146254 discloses inhibiting the detectability of inks and toners by rendering them invisible. This objective is accomplished by including, in these inks and toners, an infrared absorption material characterized by maximum absorbance in the 750 nm-1,000 nm range, and having an absorbance, at 650 nm, that is not more than 5 percent of the indicated maximum.

### SUMMARY OF THE INVENTION

It has been discovered that the visible detectability of a toner that is optically readable in the near infrared region—this readability being provided by the presence, in the toner, of a NIR colorant with sufficient absorption in the near infrared range of the electromagnetic spectrum—can be inhibited by means of the absorbance difference in the visible range, between the toner and the substrate on which it resides, being lessened, and preferably eliminated.

Further in this regard with respect to the visible range, and as to the color yellow in particular, it happens that yellow images are difficult for the eye to resolve—i.e., the ability of the eye to distinguish details in yellow is very poor. And it is yet additionally a peculiarity of the eye's function that the resolvability of a yellow image is especially diminished where the yellow image is on a yellow background. With toners, and substrates like paper, being employed to provide the respective images and background, these effects occur where the toners have an absorbance of 0.1 to 0.6 at 450 nm, less than 0.2 at 550 nm, and less than 0.1 at 650 nm—and accordingly are yellow—and the substrates, such as paper, have an absorbance of 0.1 to 0.6 at 450 nm, less than 0.2 at 550 nm, and less than 0.1 at 650 nm—and accordingly likewise are yellow.

It follows that where the toner and substrate have these absorbances, at these wavelengths in the visible region, then here too the visible detectability of the toner is inhibited. And along with this inhibited visible detectability, the toner can be rendered optically readable in the near infrared region by providing both that the toner has an absorbance of greater than 0.1 at 935 nm, and that the substrate has an absorbance of less than 0.1 at 935 nm.

With respect to the foregoing, the invention pertains to a substrate having a toner situated thereon, with the toner comprising a binder resin and a NIR colorant. In one embodiment, the toner-substrate absorbance difference is 0.2 or less, or about 0.2 or less, at 450 nm, at 550 nm, and at 650 nm, and 0.1 or greater, or about 0.1 or greater, at 935 nm. In another embodiment, the substrate has an absorbance of 0.1 to 0.6, or about 0.1 to about 0.6, at 450 nm, an absorbance of less than 0.2, or less than about 0.2, at 550 nm, an absorbance of less than 0.1, or less than about 0.1, at 650 nm, and an absorbance of less than 0.1, or less than about 0.1, at 935 nm, and the toner has an absorbance of 0.1 to 0.6, or about 0.1 to about 0.6, at 450 nm, an absorbance of less than 0.2, or less than about 0.2, at 550 nm, an absorbance of less than 0.1, or less than about 0.1, at 650 nm, and an absorbance of greater than 0.1, or greater than about 0.1, at 935 nm.

The invention further pertains to a method for reproducibly identifying one or more positions in sequence on a substrate, with the substrate bearing a toner-formed pattern that enables reproducible identification of the one or more positions in sequence. The toner comprises a binder resin and also a NIR colorant. In one embodiment, the toner-substrate absorbance difference is 0.2 or less, or about 0.2 or less, at 450 nm, at 550 nm, and at 650 nm, and 0.1 or greater, or about 0.1 or greater, at 935 nm. In another embodiment, the substrate has an absorbance of 0.1 to 0.6, or about 0.1 to about 0.6, at 450 nm, an absorbance of less than 0.2, or less than about 0.2, at 550 nm, an absorbance of less than 0.1, or less than about 0.1, at 650 nm, and an absorbance of less than 0.1, or less than about 0.1, at 935 nm, and the toner has an absorbance of 0.1 to 0.6, or about 0.1 to about 0.6, at 450 nm, an absorbance of less than 0.2, or less than about 0.2, at 550 nm, an absorbance of less than 0.1, or less than about 0.1, at 650 nm, and an absorbance of greater than 0.1, or greater than about 0.1, at 935 nm. The method comprises sequentially scanning one or more positions on the substrate, and processing the resulting sequence of one or more positions. This processing comprises at least one member selected from the group consisting of displaying the sequence, and storing the sequence for display.

The invention yet additionally pertains to a method for preparing a substrate having a toner situated thereon. Here also, in one embodiment, the toner comprises a binder resin and a NIR colorant, and the toner-substrate absorbance difference is 0.2 or less, or about 0.2 or less, at 450 nm, at 550 nm, and at 650 nm, and 0.1 or greater, or about 0.1 or greater, at 935 nm. In another embodiment, the substrate has an absorbance of 0.1 to 0.6, or about 0.1 to about 0.6, at 450 nm, an absorbance of less than 0.2, or less than about 0.2, at 550 nm, an absorbance of less than 0.1, or less than about 0.1, at 650 nm, and an absorbance of less than 0.1, or less than about 0.1, at 935 nm, and the toner has an absorbance of 0.1 to 0.6, or about 0.1 to about 0.6, at 450 nm, an absorbance of less than 0.2, or less than about 0.2, at 550 nm, an absorbance of less than 0.1, or less than about 0.1, at 650 nm, and an absorbance of greater than 0.1, or greater than about 0.1, at 935 nm. This method comprises contacting an electrostatic image with at least one magnetic brush to develop the electrostatic image, and transferring the resulting toned electrostatic image to the substrate. The at least one magnetic brush comprises a rotating magnetic core of a preselected magnetic field strength, an outer nonmagnetic shell disposed about the rotating magnetic core, and an electrographic developer composition disposed on an outer surface of the shell and in contact with the image. The developer composition comprises charged toner particles and oppositely charged hard magnetic carrier particles, with the charged toner particles comprising the toner as indicated.

### BRIEF DESCRIPTION OF THE DRAWINGS

FIGS. 1 and 2 are graphs showing the spectral absorption curves of control toners.

FIGS. 3-7 are graphs showing the spectral absorption curves of toners of the invention.

### DESCRIPTION OF THE INVENTION

The absorbance exhibited by a material is a measurement of the amount of light absorbed, by the material, as a function of wavelength on the electromagnetic spectrum. Absorbance is defined as follows:
A=log₁₀(Rₛ/Rₚ)
wherein:

A=absorbance;

Rₛ=amount of light reflected from a reference standard; and

Rₚ=amount of light reflected from the surface of the material.

Absorbance is measured on a UV/Vis Spectrometer, Lambda 2S, from PerkinElmer, Inc., Boston, Mass., equipped with a RSA-PE-20 Integrating Sphere. The reference standard is SRS-99-010.

“Toner-substrate absorbance difference”, for the toner and the substrate on which the toner resides, is the difference between:

the absorbance of the substrate alone; and

the absorbance that would be obtained from the combination of the toner and the portion of the substrate residing directly under the toner, if the toner had been deposited on this portion of the substrate at least essentially uniformly, at a coverage of 0.48 mg/cm², and had been fixed to the substrate with heat and pressure by passing through an Ektaprint EK95™ roller fuser, from Eastman Kodak Company, Rochester, N.Y., at 204° C. and 91 cm/sec.

Where the substrate is paper, this absorbance difference can be referred to as “toner-paper absorbance difference”.

Color is measured using the 1976 CIELAB color difference metric. In accordance therewith, a color is defined by its L*, a*, and b* color coordinates, and the difference between two colors, BE, is calculated as follows:
ΔE=[ΔL*²+Δa*²+Δb*²]

The color coordinates are calculated using a Gretag SPM 100 spectrometer, from Gretag AG, Regensdorf, Switzerland, with selection of a D50 illuminant and a 2 degree observer, and absolute measurement.

“Toner-substrate ΔE”, for the toner and the substrate on which the toner resides, is the difference between:

the color of the substrate alone; and

the color of the toner, if the toner had been deposited on the portion of the substrate on which it resides at least essentially uniformly, at a coverage of 0.48 mg/cm², and had been fixed to the substrate with heat and pressure by passing through an Ektaprint EK95™ roller fuser at 204° C. and 91 cm/sec.

Where the substrate is paper, this color difference can be referred to as “toner-paper ΔE”.

Particle size is understood, unless stated otherwise, as referring to average particle diameter.

With reference to magnetic materials, the terms “hard” and “soft” have the generally accepted meaning as indicated on page 18 of Introduction to Magnetic Materials by B.D. Cullity, published by Addison-Wesley Publishing Company, 1972. This publication is incorporated herein in its entirety, by reference thereto.

Toners of the invention include at least one binder resin, and at least one colorant. A toner of the invention can also include additional components, such as at least one charge control agent, at least one release agent, and other addenda and additives.

Among the binder resins that may be used are those selected from both natural and synthetic resins and modified natural resins, such as the resins disclosed in U.S. Pat. No. 4,076,857, which is incorporated herein in its entirety, by reference thereto. The polymers disclosed in U.S. Pat. Nos. 3,938,992, 3,941,898, and 4,833,060 also may be used; these patents as well are incorporated herein in their entireties, by reference thereto.

Moreover, suitable binder resins include polyesters, such as clear polyesters; polymers of styrene/butadiene, styrene/methacrylate, styrene and acrylate; polyamides, epoxies, polyurethanes, vinyl resins and polymeric esterification products of a dicarboxylic acid and a diol comprising a diphenol. Vinyl resins that may be used include homopolymers or copolymers of two or more vinyl monomers. Typical examples of vinyl monomeric units include: styrene, p-chlorostyrene vinyl naphthalene, vinyl chloride, vinyl bromide, vinyl fluoride, ethylenically unsaturated monoolefins such as ethylene, propylene, butylene, isobutylene and the like; vinyl esters such as vinyl acetate, vinyl propionate, vinyl benzoate, vinyl butyrate and the like; esters of alphamethylene aliphatic monocarboxylic acids such as methyl acrylate, ethyl acrylate, n-butylacrylate, isobutyl acrylate, dodecyl acrylate, n-octyl acrylate, 2-chloroethyl acrylate, phenyl acrylate, methylalpha-chloroacrylate, methyl methacrylate, ethyl methacrylate, butyl methacrylate and the like; acrylonitrile, methacrylonitrile, acrylamide, vinyl ethers such as vinyl methyl ether, vinyl isobutyl ether, vinyl ethyl ether, and the like; vinyl ketones such as vinyl methyl ketone, vinyl hexyl ketone, methyl isopropenyl ketone and the like; vinylidene halides such as vinylidene chloride, vinylidene chlorofluoride and the like; and N-vinyl indole, N-vinyl pyrrolidene and the like; and mixtures thereof.

The preferred toner resins of the present invention are selected from the polystyrene methacrylate resins, polyester resins including those disclosed in U.S. Pat. No. 3,655,374, which is incorporated herein in its entirety by reference thereto, and polyester resins resulting from the condensation of dimethylterephthalate, 1,3 butanediol, and pentaethythriol.

The at least one binder resin preferably comprises at least about 50 percent by weight of the toner. For instance, the at least one binder resin can comprise from about 60 percent by weight, or about 75 percent by weight, to about 85 percent by weight, or about 90 percent by weight, or about 99 percent by weight, of the toner.

NIR colorants of the invention, such as NIR dyes and NIR pigments, are those that, when incorporated in a clear polyester binder resin, to provide a composition that is fixed to a specified substrate—the incorporation and fixing being conducted in accordance with the following procedure, the substrate being a particular paper as subsequently identified, and the proportion of colorant to resin being one part colorant per one hundred parts by weight resin—provide a fused composition that, in combination with the portion of the substrate residing directly thereunder, has an absorbance of less than 0.6 at 450 nm, less than 0.3 at 550 nm and at 650 nm, and greater than 0.2 at 935 nm.

As to the indicated procedure and substrate, the colorant and resin are compounded on a two-roll mill, until the colorant is distributed at least essentially uniformly in the resin. The resulting composition is pulverized to yield a powder having a particle size of 7 to 13 microns. This composition is deposited, at least essentially uniformly, on Hammermill White Copy Paper, S20, 19800-2, from International Paper Company, Memphis, Tenn., at a coverage of 0.48 mg/cm². The deposited composition is fixed to the paper with heat and pressure by passing through an Ektaprint EK95™ roller fuser at 20.4° C. and 91 cm/sec. The absorbance of the fused composition is measured on a UV/Vis Spectrometer, Lambda 2S, equipped with a RSA-PE-20 Integrating Sphere, and with the reference standard being SRS-99-010.

Among the NIR colorants of the invention are those that are yellow, and that, under the foregoing conditions, result in an absorbance of 0.1 to 0.6, or about 0.1 to about 0.6, at 450 nm, an absorbance of less than 0.2, or less than about 0.2, at 550 nm, an absorbance of less than 0.1, or less than about 0.1, at 650 nm, and an absorbance of greater than 0.1, or greater than about 0.1, at 935 nm. One such commercially available yellow NIR colorant is the subsequently discussed Epplight 2057.

Suitable NIR dyes include the tris amminium NIR dyes. Also suitable are the dithiolene NIR dyes; of these dithiolene NIR dyes, the nickel dithiolene NIR dyes are especially preferred.

A commercially available tris amminium NIR dye that may be used is Epolight 2057, and commercially available nickel dithiolene NIR dyes that may be used are Epolight 3063 and Epolight 3138. These are sold by Epolin, Inc., Newark, N.J.

The Epolight 2057, Epolight 3063, and Epolight 3138 NIR dyes have the properties as shown on their respective epolin.com/d2057.html, epolin.com/d3063.html, and epolin.com/ d3138.html information sheets from the epolin.com website, as printed out on Jan. 15, 2004. These Jan. 15, 2004 printed out information sheets are incorporated herein in their entireties, by reference thereto.

The indicated properties of the Epolight 2057, Epolight 3063, and Epolight 3138 NIR dyes include all of the information provided on the Jan. 15, 2004 sheets—that of the absorbance and wavelength graphs, as well as the data from the tables. As to the data from the tables, the Epolight 2057 NIR dye has a λMax of 990 nm, an absorptivity of 61, a melt point of 104° C.-108° C., and a solubility in grams per 100 grams of solvent as follows: methyl ethyl ketone (MEK), greater than 30.0 grams; isopropyl alcohol (IPA), 0.14 grams; ethyl acetate, 2.6 grams; tetrahydrofuran (THF), greater than 6.0 grams; cyclohexanone, greater than 6.0 grams. Further, the Epolight 3063 NIR dye has a λMax of 856 nm, an absorptivity of 55, a melt point of 293° C., and a solubility in grams per 100 grams of solvent as follows: MEK, 0.28 grams; xylene, 0.19 grams; THF, 1.42 grams; cyclohexanone, 0.38 grams. Yet additionally, the Epolight 3138 NIR dye has a λmax of 925 nm, an absorptivity of 57, a melt point of 290° C.-292° C., and a solubility in grams per 100 grams of solvent as follows: MEK, 0.22 grams; xylene, 2.24 grams; THF, 4.49 grams; cyclohexanone, 1.61 grams.

The at least one NIR colorant preferably comprises from about 0.1 percent by weight, or about 0.3 percent by weight, or about 0.6 percent by weight, to about 1 percent by weight, or about 3 percent by weight, or about 6 percent by weight, of the toner.

Suitable charge control agents include the metal salts of 3,5 ditert-butyl salicylic acid. Among the specific charge control agents that may be used are the zinc complex of ditertbutyl salicylic acid, and the aluminum complex of ditertbutyl salicylic acid. A preferred commercially available zinc complex of ditertbutyl salicylic acid is BONTRON E-84, and a preferred commercially available aluminum complex of ditertbutyl salicylic acid is BONTRON E-88, both from Orient Corporation of America, Kenilworth, N.J. The at least one charge control agent preferably comprises from about 0.01 percent by weight, or about 0.1 percent by weight, or about 0.2 percent by weight, to about 1.5 percent by weight, or about 2 percent by weight, or about 3 percent by weight, of the toner.

Among the suitable release agents are polyolefin waxes, such as low molecular weight polyethylene waxes and low molecular weight polypropylene waxes, ethylene-propylene copolymers, microcrystalline waxes, carnauba wax, and paraffin wax. Commercially available release agents that may be used include Polywax® 2000 and Polywax® 3000 polyethylene waxes, from Baker Petrolite, Baker Hughes Incorporated, Sugar Land, Tex. The at least one release agent preferably comprises from about 0.1 percent by weight, or about 1 percent by weight, to about 5 percent by weight, or about 15 percent by weight, of the toner.

Other addenda and additives that are suitable for the toner include magnetic pigments, leveling agents, surfactants, and stabilizers. Surface treatments such as fumed silica, fumed alumina, microbeads, and the like, as are known in the art, may also be used. Each can be used in conventional amounts, as are known in the art; preferably, the total quantity of these other addenda and additives comprises not more than about 10 percent by weight of the toner.

The toner can be prepared by various known suitable methods. For instance, the toner can be prepared using the following procedure: admixing the binder resin, the NIR component, and any other components that are being included; milling and heating this admixture to disperse the NIR component, and any other components that are employed, in the resin, and to obtain a heated mass; cooling this mass, crushing it into lumps, and finely grinding it.

Toner particles can range in diameter from about 0.5 to about 25 microns with an average size of from about 1 to about 16 microns, preferably from about 4 to about 12 microns. Toner particle size is the particle size as determined by a Coulter Counter Multisizer™ (Beckman Coulter, Fullerton, Calif.). The toner particles made by the foregoing method are varied in size, and irregular in shape.

The shape of the toner particles accordingly can be irregular, and the toner particles can be varied in size, but the toner can be any shape, regular or irregular. Spherically shaped particles can be obtained by spray-drying a solution of the toner resin mixture in a solvent. Alternatively, spherical particles can be prepared by the polymer bead swelling techniques, such as those described in European Patent No. 3905, published Sept. 5, 1979, as well as by suspension polymerization, such as by the method disclosed in U.S. Pat. No. 4,833,060; European Patent No. 3905, published Sept. 5, 1979, is incorporated herein in their entireties, by reference thereto.

Toners of the invention include those that have an absorbance of 0.1 to 0.6, or about 0.1 to about 0.6, at 450 nm, an absorbance of less than 0.2, or less than about 0.2, at 550 nm, an absorbance of less than 0.1, or less than about 0.1, at 650 nm—and accordingly are yellow—along with an absorbance of greater than 0.1, or greater than about 0.1, at 935 nm. Toners that incorporate Epolight 2057 as an NIR colorant are suitable such toners.

The carrier of the invention comprises a hard magnetic carrier, that is preferably in the form of magnetically attractable particles—specifically, of hard magnetic carrier particles. The carrier is, as a matter of particular preference, a hard magnetic particulate material exhibiting a coercivity of at least about 300 gauss when magnetically saturated and also exhibits an induced magnetic moment of at least about 20 EMU/gm when in an externally applied field of 1000 gauss. The carrier particles have a sufficient opposite charge and magnetic moment to prevent the carrier particle from transferring to the electrostatic image.

Useful hard magnetic materials include ferrites and gamma ferric oxide. Preferably, the carrier particles are composed of ferrites, which are compounds of magnetic oxides containing iron as a major metallic component. For example, useful compounds include ferric oxide, Fe₂O₃, formed with basic metallic oxides such as those having the general formula MFeO₂ or MFe₂O₄ wherein M represents a mono- or di-valent metal and the iron is in the oxidation state of +3.

Preferred ferrites are those containing barium and/or strontium, such as BaFe₁₂O₁₉, SrFe₁₂O₁₉, and the magnetic ferrites having the formula MO.6Fe₂O₃, wherein M is barium, strontium, or lead, as disclosed in U.S. Pat. No. 3,716,630. This patent is incorporated herein in its entirety, by reference thereto.

Among the hard magnetic materials, carriers, and carrier particles that may be used are those as disclosed in U.S. Pat. Nos. 4,473,029, 4,546,060, and 6,589,703. These patents also are incorporated herein in there entireties, by reference thereto.

The hard magnetic carrier particles preferably have a particle size of from about 5 microns, or about 10 micron, or about 15 microns, to about 20 microns, or about 50 microns, or about 100 microns.

The developer composition, or developer, comprises, or consists essentially of, or consists of, toner and hard magnetic carrier. The developer can be prepared by any suitable method. Preferably, the developer is formed by mixing the carrier particles and the toner particles in suitable concentrations.

Particularly, preferably the developer comprises charged toner particles and oppositely charged carrier particles comprising a hard magnetic material. In the developer composition, the carrier particles serve as sites against which the nonmagnetic toner particles can impinge, and thereby acquire a triboelectric charge. The toner particles accordingly are adhered to the carrier particles via triboelectric forces.

The developer preferably comprises, or consists essentially of, or consists of, from about 70 percent by weight, or about 75 percent by weight, or about 80 percent by weight, or about 85 percent by weight, or about 90 percent by weight, or about 95 percent by weight, to about 99 percent by weight carrier. Also, the developer preferably comprises from about 1 percent by weight to about 5 percent by weight, or about 10 percent by weight, or about 15 percent by weight, or about 20 percent by weight, or about 25 percent by weight, or about 30 percent by weight, toner.

Usually, carrier particles are larger than toner particles. Preferably, the particle size ratio of toner to carrier particles is from about 1:1 to about 1:50. More preferably, the particle size ratio of toner to carrier particles is from about 1:1 to about 1:15.

Substrates of the invention include those that have an absorbance of 0.1 to 0.6, or about 0.1 to about 0.6, at 450 nm, an absorbance of less than.0.2, or less than about 0.2, at 550 nm, an absorbance of less than 0.1, or less than about 0.1, at 650 nm—and accordingly are yellow—along with an absorbance of less than 0.1, or less than about 0.1, at 935 nm. Preferably the substrate of the invention is paper. Suitable paper includes that having an absorbance of 0.1 to 0.6, or about 0.1 to about 0.6, at 450 nm, an absorbance of less than 0.2, or less than about 0.2, at 550 nm, an absorbance of less than 0.1, or less than about 0.1, at 650 nm—and that accordingly is yellow—along with an absorbance of less than 0.1, or less than about 0.1, at 935 nm. The original, Canary Yellow Post-It® Notes, from 3M Company, St. Paul, Minn., are one such commercially available paper.

In the development process, the original to be copied is rendered in the form of a latent electrostatic image on an electrostatic image member—e.g. a photosensitive member, a photoconductive recording element. In this regard, the original to be copied can be rendered in the form of a latent electrostatic image on a dielectric surface, such as on the surface of the electrostatic image member.

The latent electrostatic image is developed by moving the electrostatic image member, bearing the electrostatic image, through a development zone, with the developer also being transported through the development zone. The image accordingly is moved into proximity with the developer composition. The triboelectric charge, of the toner component of the developer composition, is either the same as or opposite to the charge of the electrostatic, image, depending on whether discharged or charged area development is employed. When the electrostatic image is in proximity with the developer, the toner particles are stripped from the carrier particles by the relatively strong electrostatic forces associated with the charge image. In this manner, the toner particles are deposited on, and thereby develop, the electrostatic image.

The developer composition is applied to the electrostatic image by means of a magnetic applicator comprising a cylindrical sleeve, or shell, of nonmagnetic material having a magnetic core positioned within. Preferably, the nonmagnetic sleeve, or shell, is cylindrical.

The core comprises a plurality of parallel magnetic pole portions, or strips, which are arranged around the core surface, around the core periphery, in alternating magnetic polarity relation, to present alternating north and south oriented magnetic fields. These fields project radially, through the sleeve, or shell, and serve to attract the developer composition to the sleeve or shell outer surface to form what is referred to as a “brush” or “nap”. The core preferably has a preselected magnetic field strength.

The core is rotatable on—rotates on—an axis within the sleeve, or shell. In this regard, the core is rotated—and the sleeve or shell can rotate, or it can be stationary—to cause the developer to advance from a supply sump, to a position in proximity to the electrostatic image to be developed.

Accordingly, the sleeve, or shell, can be rotating or stationary. It transports the developer from the supply to the development zone, in development relation with the latent electrostatic image of the electrostatic image member. Particularly, with the toner of the developer, in the development zone, being transferred to the electrostatic image, the sleeve, or shell, can be rotated to increase the velocity of the developer.

Preferably, the sleeve, or shell, and the core, are rotated with respect to each other, to cause the indicated advance of the developer. Means for rotating the core—and if it also rotates, the shell, or sleeve—are present, in order to deliver the developer to the development zone.

If the sleeve or shell does rotate, it can rotate in the opposite direction to the rotation of the core; the sleeve or shell, and the core, can rotate in mutual opposition—i.e., in opposition to each other. For instance, the core can rotate clockwise, with the sleeve or shell rotating counterclockwise. Or the core can rotate counterclockwise, with the sleeve or shell rotating clockwise.

Alternatively, if the sleeve or shell-does rotate, it can rotate in the same direction as the core. For instance, the core and sleeve, or shell, can both engage in clockwise rotation, or they can both engage in counterclockwise rotation.

In accordance with the foregoing, the developer is moved in the direction of the electrostatic image to be developed by high speed rotation of the multipole magnetic core within the sleeve, or shell, with the developer being disposed on the outer surface of the sleeve, or shell. As indicated, the sleeve, or shell, may also be rotated. The direction and speed of the core and optionally sleeve (or shell) rotations are controlled so that the developer flows through the development zone in a direction cocurrent with the electrostatic image member movement.

Rapid pole transitions on the sleeve are mechanically resisted by the carrier because of its high coercivity. Chains of carrier particles comprising the nap of the carrier (with toner particles disposed on the surface of the carrier particles), rapidly “flip” on the sleeve in order to align themselves with the magnetic field reversals imposed by the rotating magnetic core, and as a result, move with the toner on the sleeve through the development zone in actual contact with, or in proximity and developing relationship to, the electrostatic image on a photoconductor. This interaction of the developer with the charge image can be referred to as “contact” or “contacting”.

The magnetic core can be rotated, for example, at a speed of 2000 rpm. Pole transitions occur, for example, as frequently as 467 per second at the sleeve surface, when the magnetic core is rotated at this speed. Such rapid pole transitions create a highly energetic and vigorous movement of the developer as it moves through development zone. This vigorous action constantly recirculates the developer to the sleeve surface and then back to the outside of the nap to provide toner for development. This flipping action also results in a continuous feed of fresh toner particles to the image. This method provides high density, high quality images at relatively high development speeds.

The electrostatic image so developed can be formed by a number of methods, such as by imagewise photodecay of a photoreceptor, or imagewise application of a charge pattern on the surface of a dielectric recording element. When photoreceptors are used, such as in high speed electrophotographic copy devices, the use of halftone screening to modify an electrostatic image is particularly desirable—the combination of screening with development in accordance with the present method producing high quality images exhibiting Dmax and excellent tonal range. Representative screening methods include those employing photoreceptors with integral halftone screen, such as those described U.S. Pat. No. 4,385,823, which is incorporated herein in its entirety, by reference thereto.

Developers in the present development system preferably are capable of delivering toner to a charged image at high rates, and hence are particularly suited to high volume electrophotographic printing applications and copying applications.

The setup of the development system is preferably a digital printer, such as a Heidelberg DigiMasterm 9110 printer, from Heidelberg Digital L.L.C., Rochester, N.Y., using a development station comprising a magnetic brush comprising a nonmagnetic, cylindrical shell or sleeve, a magnetic core, and means for rotating the magnetic core and optionally the shell or sleeve as described, for instance, in U.S. Pat. Nos. 4,473,029, and 4,546,060.

Development may be effected using the methods and systems as disclosed in U.S. Pat. Nos. 4,473,029, 4,546,060, 4,764,445, 5,376,492, 6,589,703, and 6,610,451. U.S. Pat. Nos. 4,764,445, 5,376,492, and 6,610,451 are incorporated herein in their entireties, by reference thereto.

After development, the toner depleted carrier particles are returned to the sump for toner replenishment. Also after development, the resulting toned electrostatic image is transferred to a substrate, such as a receiver sheet—e.g., paper—and particularly is transferred to the substrate surface, so that the toner is situated, or resides, on the substrate—on its surface.

The toner situated, or residing, on the substrate—on its surface—is fixed, or fused, thereto by applying heat to this toner, to soften it, and then allowing or causing the toner to cool. This application of heat in the fusing process is preferably at a temperature of about 90° C.-220° C.; pressure may be employed in conjunction with the heat.

A system or assembly for providing the requisite heat and pressure is generally provided as a fusing subsystem, and customarily includes a fuser member and a support member. The various members that comprise the fusing subsystem are considered to be fusing members; of these fusing members, the fuser member is the particular member that contacts the toner to be fused by the fusing subsystem.

The heat energy employed in the fusing process generally is transmitted to toner on the substrate by the fuser member. Specifically, the fuser member is heated; to transfer heat energy to toner situated on the substrate, the fuser member contacts this toner, and correspondingly also can contact the substrate—the surface of the substrate—itself. The support member also contacts the substrate—an opposing surface of the substrate.

Accordingly, the substrate can be situated or positioned between the fuser and support members, so that these members can act together on the substrate to provide the requisite pressure in the fusing process. In cooperating, preferably the fuser and support members define a nip, or contact arc, in which the substrate is positioned or resides, and/or through which the substrate passes. Also as a matter of preference, the fuser and support members are in the form of fuser and pressure rollers, respectively. Yet additionally as a matter of preference, one or both of the fuser and support members have a soft layer that increases the nip, to effect better transfer of heat to fuse the toner.

In one embodiment, the substrate, with the toner situated, or residing thereon—the substrate, with the toner fixed, or fused thereto—is characterized by a toner-substrate absorbance difference of 0.2 or less, or about 0.2 or less, at 450 nm, at 550 nm, and at 650 nm, and 0.1 or greater, or about 0.1 or greater, at 935 nm.

In another embodiment, the substrate, with the toner situated, or residing thereon—the substrate, with the toner fixed, or fused thereto—is characterized by the substrate having an absorbance of 0.1 to 0.6, or about 0.1 to about 0.6, at 450 nm, an absorbance of less than 0.2, or less than about 0.2, at 550 nm, an absorbance of less than 0.1, or less than about 0.1, at 650 nm, and an absorbance of less than 0.1, or less than about 0.1, at 935 nm, and the toner having an absorbance of 0.1 to 0.6, or about 0.1 to about 0.6, at 450 nm, an absorbance of less than 0.2, or less than about 0.2, at 550 nm, an absorbance of less than 0.1, or less than about 0.1, at 650 nm, and an absorbance of greater than 0.1, or greater than about 0.1, at 935 nm. For instance, paper in the form of the original Canary Yellow Post-It® Notes, may be used with toner having Epolight 2057 as the colorant.

With the foregoing embodiments of the substrate plus toner combination, the visible detectability of the toner is inhibited—lessened, or even prevented—while the toner is optically detectable in the near infrared region of the electromagnetic spectrum. These properties are achieved by the difference in absorbance between the toner and the substrate being reduced in the visible region of the electromagnetic spectrum, or even eliminated, with the toner incorporating a colorant that is characterized by sufficient absorbance in the near infrared region.

And particularly with respect to the latter embodiment, the difficulty of resolving the toner—because of the indicated absorbances of the toner and the substrate in the visible region—especially inhibits the visible detectability of the toner on the substrate.

The toner bearing substrate of the invention can be employed for the purpose of providing markings that are at least difficult to discern visually, and preferably visually indiscernible, but readable by an optical device that detects in the infrared region. So this substrate plus toner combination is useful for such purposes as document tamper protection, security encoding, and document authentication. For instance, the present toner bearing substrate can be used in the processes as disclosed in U.S. Pat. No. 5,208,630, which is incorporated herein in its entirety, by reference thereto.

Further in this regard, it is known to employ digital means with a pattern-bearing substrate—with a substrate bearing a pattern on its surface—for determining, for reproducibly identifying, a sequence of one or more points, or positions, on the substrate, on the substrate surface—particularly, where this sequence is in the form of writing or drawing on the substrate, on the substrate surface. The indicated sequence is processed into signals, for storage and/or transmission.

With regard to the foregoing, a substrate, the surface of a substrate, is provided, preferably is printed, with a particular pattern. This pattern enables a scanning device, moving over the pattern, to determine the sequence of the one or more points, or positions, that are tracked by this movement.

The scanning device performs this function, reproducibly identifying the position sequence, by optically reading the indicated pattern. The location of the scanning device, with respect to the substrate, with respect to its surface, is continually recorded as the device is passed over the substrate—over the substrate surface.

The indicated position sequence can be stored and/or transmitted. It can be transformed into a suitable form of communication, such as electronic mail and/or facsimile transmission.

The scanning device can be provided in the form of a writing implement, such as a digital pen that has an optical sensor, or camera, embedded therein. Accordingly, this scanning device, this instrument, preferably is equipped not only to track and reproducibly identify the position sequence, as indicated, but also to perform as writing implements ordinarily perform—to be employed as writing implements conventionally are used. The instrument therefore can be furnished with marking material, such as ink, to be transferred to the substrate as the position sequence is scanned.

So what is being written on the substrate also is processed for the indicated storage and/or transmission. The writing implement keeps digital records of what is written or drawn—it records what it writes or draws, as it writes or draws, digitizing words and images.

Anoto AB, a Swedish corporation, markets products and services for the foregoing technology. The particular system of Anoto AB employs paper printed with a proprietary pattern, and a digital pen to store and transmit what is written or drawn with the pen. Resolution is believed to be 30 microns, with the pattern comprising, or consisting essentially of, or consisting of, dots with a nominal spacing of 0.3 mm (0.01 inch). These dots are slightly displaced from a grid structure to form the pattern.

When writing or drawing is performed on paper printed with the pattern, a camera in the pen registers the pen's movement across the grid surface of the paper. Digital snapshots of the pattern are taken at a rate of more than 50 per second. Every snapshot contains enough information to make a calculation of the position of the pen.

The pen's indicated movement thusly is stored as a sequence of map coordinates that corresponds to the location of the page being written or drawn upon. This sequence can be translated into an image of what was written or drawn—an image that comprises a copy of the writing or drawing. The sequence (and therefore the image) can be stored and transmitted, using computer and communications technology as is known. It can be preserved as data in suitable storage media; it can be transformed, e.g., into emails and faxes.

The substrate plus toner combination of the invention can provide the indicated pattern bearing substrate, with the toner forming the pattern. For use with this thusly patterned substrate, the scanning device can be configured to optically read the toner by detecting the NIR component thereof.

The distinguishability of the toner from substrate thereby is lessened, and preferably is eliminated, or at least substantially or essentially eliminated, in accordance with the toner-substrate absorbance difference of the substrate plus toner combination, in the visible region. The discernibility of the pattern on the substrate accordingly is lessened or eliminated. Visible distraction resulting from the presence of the pattern thereby can be lessened or eliminated. Correspondingly the appearance of the substrate can be improved.

The present invention, particularly the substrate plus toner combination of the present invention can be employed with the products, systems, methods, devices, surfaces, storage media, and computer programs as disclosed in U.S. Pat. Nos. 6,502,756, 6,570,104, 6,548,768, and 6,586,688. These patents are incorporated herein in their entireties, by reference thereto.

The invention is illustrated by the following procedures; these are provided for the purpose of representation, and are not to be construed as limiting the scope of the invention. Unless stated otherwise, all percentages, parts, etc. are by weight.

### Experimental Procedures

### Example 1

### Preparation of Control Clear Toner A

A toner sample was prepared by compounding on a two-roll mill 100 parts by weight a crosslinked polyester resin (6EXP, NexPress Solutions LLC, Rochester, N.Y.), 4 parts polyethylene wax (Polywax® 3000, Baker Petrolite, Sugar Land, Tex.), and 2 parts charge control agent (Bontron® E-84, Orient Corporation of America, Kenilworth, N.J.). The sample was then pulverized to yield a toner with a particle size of 7 to 13 microns.

### Example 2

### Preparation of Control Black Toner B

A toner sample was prepared in a similar manner to Example 1 except that 7 parts of carbon black (Regal®330, Cabot Corporation, Billerica, Mass.) was also added on the two-roll mill.

### Example 3

### Preparation of NIR Toner C

A toner sample was prepared in a similar manner to Example 1 except that 0.33 parts of a near infrared absorbing (NIR) colorant (Epolight 2057) was also added on the two-roll mill.

### Example 4

### Preparation of NIR Toner D

A toner sample was prepared in a similar manner to Example 1 except that 1 part of a NIR colorant (Epolight 2057) was also added on the two-roll mill.

### Example 5

### Preparation of NIR Toner E

A toner sample was prepared in a similar manner to Example 1 except that 0.33 parts of a NIR colorant (Epolight 3063) was also added on the two-roll mill.

### Example 6

### Preparation of NIR Toner F

A toner sample was prepared in a similar manner to Example 1 except that 1 part of a NIR colorant (Epolight 3063) was also added on the two-roll mill.

### Example 7

### Preparation of NIR Toner G

A toner sample was prepared in a similar manner to Example 1 except that 1 part of a NIR colorant (Epolight 3138) was also added on the two-roll mill.

### Example 8

### Fixing Toners A-G onto White Paper and Measuring Their Absorbance

Toners A-G were each uniformly deposited on white paper (Hammermill White Copy Paper, S20, 19800-2) at a coverage of 0.48 mg/cm². The toner was fixed to the paper with heat and pressure by passing through an Ektaprint EK95™ roller fuser at 204° C. and 91 cm/sec. The absorbance of white paper alone and white paper plus affixed toner was measured on a UV/Vis Spectrometer, Lambda 2S, equipped with a RSA-PE-20 Integrating Sphere, and with the reference standard being SRS-99-010.

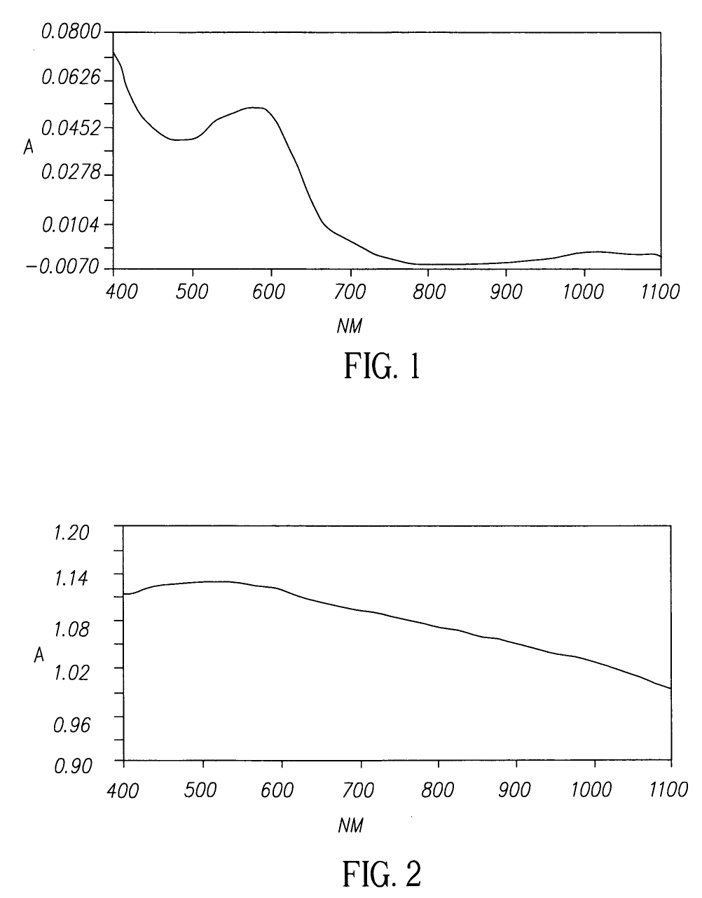

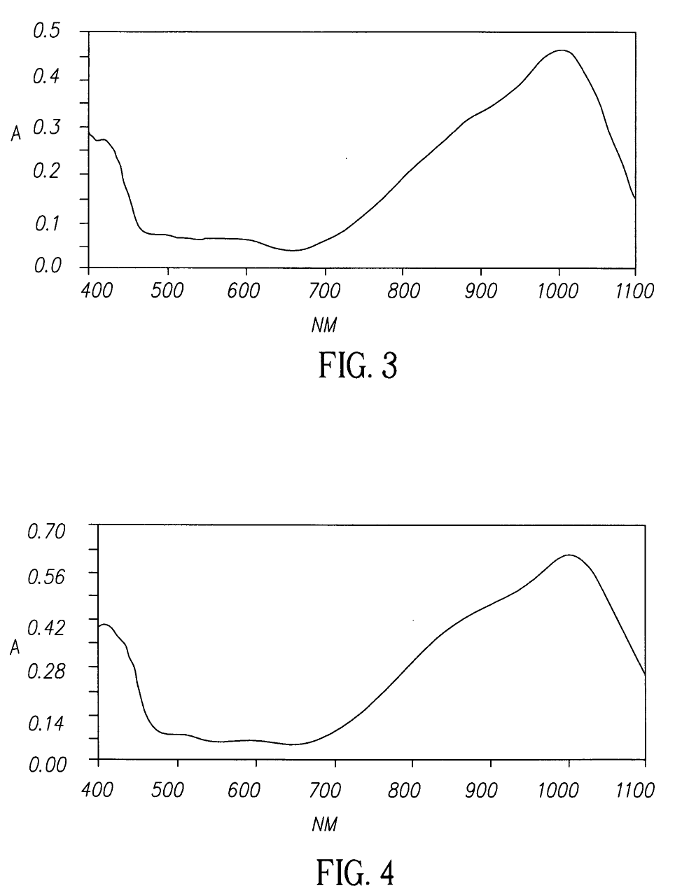

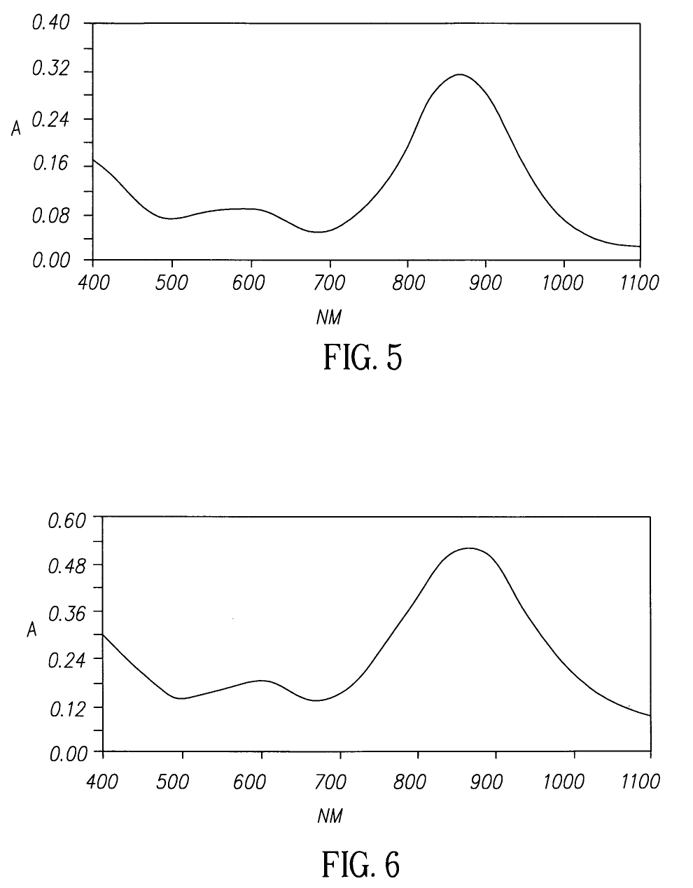

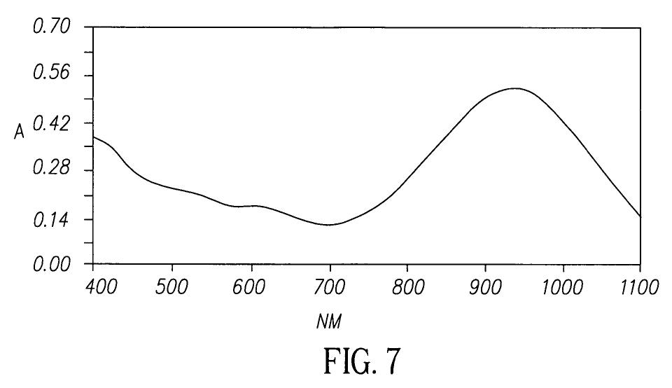

With respect to the white paper plus affixed toner samples, FIGS. 1-7 show the absorbance for each of Toners A-G, respectively, over the 400 nm-1100 nm range of the electromagnetic spectrum.

Table 1 gives the absorbance at 450, 550, 650, and 935 nm for paper alone, and for paper with affixed toner. The first three wavelengths are in the visible region of the spectrum and the last is in the infrared region. The table also gives the absorbance difference between paper with affixed toner and paper alone. A useful combination of NIR toner and paper has a difference, between the absorbance of paper alone, and the absorbance of paper with affixed toner, of 0.2 or less at 450, 550, and 650 nm, and 0.1 or greater at 935 nm.

TABLE 1
Absorbance of Toners Affixed to White Paper

| | | | | | Absorbance Difference | | | | |
|---|---|---|---|---|---|---|---|---|---|
| | | | | | Between White Paper | | | | |
| | | | | | with Affixed Toner | | | | |
| | Absorbance | | | | and White Paper Alone | | | | Useful |
| | Wavelength (nm) | | | | | | | | Toner-Paper |
| Description | 450 | 550 | 650 | 935 | 450 | 550 | 650 | 935 | Combination? |
| White Paper | 0.04 | 0.05 | 0.02 | 0 | 0 | 0 | 0 | 0 | — |
| Alone | | | | | | | | | |
| White Paper | | | | | | | | | |
| With: | | | | | | | | | |
| Clear Toner A | 0.04 | 0.05 | 0.02 | 0 | 0 | 0 | 0 | 0 | No |
| Black Toner B | 1.12 | 1.13 | 1.11 | 1.05 | 1.08 | 1.08 | 1.09 | 1.05 | No |
| NIR Toner C | 0.15 | 0.06 | 0.04 | 0.35 | 0.11 | 0.01 | 0.02 | 0.35 | Yes |
| NIR Toner D | 0.21 | 0.07 | 0.07 | 0.50 | 0.17 | 0.02 | 0.05 | 0.50 | Yes |
| IRA Toner E | 0.11 | 0.08 | 0.06 | 0.20 | 0.07 | 0.03 | 0.04 | 0.20 | Yes |
| NIR Toner F | 0.19 | 0.15 | 0.12 | 0.38 | 0.15 | 0.10 | 0.10 | 0.38 | Yes |
| NIR Toner G | 0.24 | 0.16 | 0.10 | 0.49 | 0.20 | 0.11 | 0.08 | 0.49 | Yes |

### Example 9

### Fixing Toners A-G onto Yellow Paper and Measuring Their Absorbance

Example 9 is identical to Example 8 except that in place of the white paper, yellow paper (Canary Yellow Post-It® Notes) was employed. The results are given in Table 2:

TABLE 2
Absorbance of Toners Affixed to Yellow Paper

| | | | | | Absorbance Difference | | | | |
|---|---|---|---|---|---|---|---|---|---|
| | | | | | Between Yellow Paper | | | | |
| | | | | | with Affixed Toner and | | | | |
| | Absorbance | | | | Yellow Paper Alone | | | | Useful |
| | Wavelength (nm) | | | | | | | | Toner-Paper |
| Description | 450 | 550 | 650 | 935 | 450 | 550 | 650 | 935 | Combination? |
| Yellow Paper | 0.45 | 0.04 | 0.01 | 0.01 | 0 | 0 | 0 | 0 | — |
| Alone | | | | | | | | | |
| Yellow Paper | | | | | | | | | |
| With: | | | | | | | | | |
| Clear Toner A | 0.44 | 0.04 | 0.01 | 0.01 | 0.01 | 0.00 | 0.00 | 0.00 | No |
| Black Toner B | 1.04 | 0.96 | 0.93 | 0.87 | 0.59 | 0.92 | 0.92 | 0.86 | No |
| NIR Toner C | 0.50 | 0.05 | 0.03 | 0.31 | 0.05 | 0.01 | 0.02 | 0.30 | Yes |
| NIR Toner D | 0.56 | 0.05 | 0.06 | 0.49 | 0.11 | 0.01 | 0.05 | 0.48 | Yes |
| NIR Toner E | 0.46 | 0.07 | 0.05 | 0.15 | 0.01 | 0.03 | 0.04 | 0.14 | Yes |
| NIR Toner F | 0.49 | 0.10 | 0.08 | 0.25 | 0.04 | 0.06 | 0.07 | 0.24 | Yes |
| NIR Toner G | 0.53 | 0.12 | 0.08 | 0.36 | 0.08 | 0.08 | 0.07 | 0.35 | Yes |

### Example 10

### Fixing Toners A-G onto White Paper and Measuring L*a*b* and BE

Example 10 is identical to Example 8 except that L*a*b* coordinates were measured with a Gretag SPM 100 spectrometer (Gretag AG, Regensdorf, Switzerland) using D50 illuminant, 2 degree observer, and absolute measurement for both the paper alone and paper with affixed toner. A measure of the color match, between the affixed toner and the untoned paper, is given as LE. The results are set forth in Table 3:

TABLE 3
L*a*b* and ΔE of Toners Affixed to White Paper

| Description | L* | a* | b* | ΔE |
|---|---|---|---|---|
| White Paper Alone | 94.18 | 1.17 | 0.59 | — |
| White Paper With: | | | | |
| Clear Toner A | 93.75 | 1.21 | 0.93 | 0.55 |
| Black Toner B | 32.96 | 0.75 | 0.92 | 61.22 |
| NIR Toner C | 92.63 | −2.43 | 10.36 | 10.64 |
| NIR Toner D | 91.93 | −4.75 | 17.5 | 18.06 |
| NIR Toner E | 91.19 | −0.4 | 3.08 | 4.20 |
| NIR Toner F | 87.2 | −3.16 | 6.21 | 9.25 |
| NIR Toner G | 86.28 | 1.33 | 11.16 | 13.20 |

### Example 11

### Fixing Toners A-G onto Yellow Paper and Measuring L*a*b* and ΔE

Example 11 is identical to Example 10, except that, in place of the white paper, the same type of yellow paper as that employed in Example 9 was used. As with Example 10, a measure of the color match, between the affixed toner and the untoned paper, is given as ΔE. The results are set forth in Table 4:

TABLE 4
L*a*b* and ΔE of Toners Affixed to Yellow Paper

| Description | L* | a* | b* | ΔE |
|---|---|---|---|---|
| Yellow Paper Alone | 93.68 | −4.21 | 38.84 | — |
| Yellow Paper With: | | | | |
| Clear Toner A | 93.63 | −4.14 | 38.75 | 0.12 |
| Black Toner B | 36.12 | −0.47 | 8.44 | 65.20 |
| NIR Toner C | 93.11 | −5.07 | 42.16 | 3.48 |
| NIR Toner D | 92.7 | −5.36 | 44.75 | 6.10 |
| NIR Toner E | 91.76 | −5.05 | 37.14 | 2.70 |
| NIR Toner F | 87.72 | −6.57 | 35.91 | 7.05 |
| NIR Toner G | 89.11 | −2.49 | 39.32 | 4.91 |

### Example 12

### Triboelectric Stability of a Developer Containing NIR Toner D and a Hard Magnetic Carrier

The charge stability of a developer may be simulated by shaking it for extended periods of time, with intermittent replacement of the toner. A developer to be evaluated for triboelectric stability was prepared by mixing 10 parts by weight of NIR Toner D with 90 parts of a hard magnetic strontium-ferrite carrier (FCS 190, Powdertech, Chiba-Ken, Japan).

To determine its charge stability, the developer was placed on a shaker, and subjected to agitation for a total shaking time of 64 hours. During this period, the toner was removed from the developer and replaced with fresh toner after 16, 32, and 48 hours. The triboelectric charge was measured after the 64 hours of shaking.

Preferred developers are those having an absolute charge in the range of 8-35 microcoulombs/gram after 64 hours. This developer was found to have an absolute triboelectric charge of 25 microcoulombs/gram after 64 hours.

### Example 13

### Electrophotographic Development of an Anoto Pattern with NIR Toners on Paper

Four developers were prepared by mixing 10 parts by weight of NIR Toners A, C, D, and G with 90 parts of a hard magnetic strontium-ferrite carrier (FCS 190). These developers were placed in a Heidelberg Digimaster 9110 printer (Heidelberg Digital L.L.C., Rochester, N.Y.). This printer had a development station comprising a non-magnetic, cylindrical shell, a magnetic core, and means for rotating the core and the shell. Images of an Anoto® (Anoto Group AB, Lund, Sweden) pattern were prepared on both white paper (Hammermill White Copy Paper, S20, 19800-2) and yellow paper (Post-It® Notes). For both the developer with Toner A and the developer with Toner C, two images were prepared with each of the white and yellow paper. For the other two developers, one pattern for each of the white and yellow paper was prepared.

The L*a*b* coordinates were measured with a Gretag SPM 100 spectrometer, using D50 illuminant, 2 degree observer, and absolute measurement for both the paper alone and the paper bearing the indicated pattern. A measure of the color match, between the pattern bearing paper and the untoned paper, is given as LE. The results are set forth in Table 5:

TABLE 5
L*a*b* and ΔE of Toner in an Anoto ® Pattern Affixed to Paper

| | | | | Paper plus Toner in | | | |
|---|---|---|---|---|---|---|---|
| | Paper Only | | | an Anoto ® Pattern | | | |
| Description | L* | a* | B* | L* | a* | b* | ΔE |
| White Paper | | | | | | | |
| With: | | | | | | | |
| IRA Toner A | 92.8 | 0.2 | −0.2 | 93.2 | 0.3 | 0.0 | 0.5 |
| IRA Toner A | 93.3 | 0.6 | 1.3 | 92.7 | 0.5 | 0.9 | 0.7 |
| IRA Toner C | 92.2 | 0.4 | 0.5 | 92.9 | −0.2 | 3.6 | 3.2 |
| IRA Toner C | 93.2 | 0.4 | 0.0 | 93.0 | −0.5 | 2.6 | 2.8 |
| IRA Toner D | 92.6 | 0.2 | −0.5 | 92.6 | −1.6 | 5.9 | 6.6 |
| IRA Toner G | 93.4 | 0.2 | −0.1 | 91.3 | 0.3 | 2.2 | 3.1 |
| Yellow | | | | | | | |
| Paper With: | | | | | | | |
| IRA Toner A | 90.3 | −4.4 | 36.8 | 89.7 | −4.5 | 35.0 | 1.9 |
| IRA Toner A | 89.5 | −4.8 | 35.0 | 90.1 | −4.4 | 35.5 | 0.9 |
| IRA Toner C | 89.9 | −4.8 | 35.1 | 89.7 | −4.6 | 35.8 | 0.8 |
| IRA Toner C | 90.2 | −4.8 | 36.7 | 90.4 | −4.5 | 36.3 | 0.5 |
| IRA Toner D | 90.4 | −4.4 | 36.4 | 89.3 | −5.1 | 37.5 | 1.7 |
| IRA Toner G | 90.3 | −4.4 | 35.9 | 89.9 | −4.0 | 35.7 | 0.6 |

Finally, although the invention has been described with reference to particular means, materials, and embodiments, it should be noted that the invention is not limited to the particulars disclosed, and extends to all equivalents within the scope of the claims.

1. A substrate having a toner situated thereon, the toner comprising:
(a) a binder resin; and
(b) an NIR colorant;
the substrate having an absorbance of about 0.1 to about 0.6 at 450 nm, an absorbance of less than about 0.2 at 550 nm, an absorbance of less than about 0.1 at 650 nm, and an absorbance of less than about 0.1 at 935 nm;
the toner having an absorbance of about 0.1 to about 0.6 at 450 nm, an absorbance of less than about 0.2 at 550 nm, an absorbance of less than about 0.1 at 650 nm, and an absorbance of greater than about 0.1 at 935 nm; further wherein the toner-substrate absorbance difference is about 0.2 or less at 450 nm, at 550 nm, and at 650 nm, and about 0.1 or greater at 935 nm.

2. The substrate of claim 1, wherein said NIR colorant is a tris amminium NIR dye, a dithiolene NIR dye, or a combination thereof.

3. The substrate of claim 2, wherein said NIR colorant is a nickel dithiolene NIR dye.

4. The substrate of claim 1, wherein said NIR colorant is present in an amount of from about 0.1 percent by weight to about 6 percent by weight of said toner.

5. The substrate of claim 4, wherein said NIR colorant is present in an amount of from about 0.1 percent by weight to about 3 percent by weight of said toner.

6. The substrate of claim 5, wherein said NIR colorant is present in an amount of from about 0.1 percent by weight to about 1 percent by weight of said toner.

7. The substrate of claim 4, wherein said NIR colorant is present in an amount of from about 0.3 percent by weight to about 6 percent by weight of said toner.

8. The substrate of claim 7, wherein said NIR colorant is present in an amount of from about 0.3 percent by weight to about 3 percent by weight of said toner.

9. The substrate of claim 8, wherein said NIR colorant is present in an amount of from about 0.3 percent by weight to about 1 percent by weight of said toner.

10. The substrate of claim 4, wherein said NIR colorant is present in an amount of from about 0.6 percent by weight to about 6 percent by weight of said toner.

11. The substrate of claim 10, wherein said NIR colorant is present in an amount of from about 0.6 percent by weight to about 3 percent by weight of said toner.

12. The substrate of claim 11, wherein said NIR colorant is present in an amount of from about 0.6 percent by weight to about 1 percent by weight of said toner.

13. The substrate of claim 1, further wherein said toner comprises at least 50 percent, by weight of the toner, of at least one binder resin selected from polystyrene methacrylate resin and polyester resin.

14. A method for reproducibly identifying, on a substrate, one or more positions in sequence, the substrate having toner situated thereon, the toner forming a pattern that enables reproducible identification of the one or more positions in sequence, the method comprising:
(a) sequentially scanning one or more positions on the substrate; and
(b) processing the resulting sequence of one or more positions, the processing comprising at least one member selected from the group consisting of:
(i) displaying the sequence; and
(ii) storing the sequence for display;
the toner comprising:
a binder resin; and
an NIR colorant;
the substrate having an absorbance of about 0.1 to about 0.6 at 450 nm, an absorbance of less than about 0.2 at 550 nm, an absorbance of less than about 0.1 at 650 nm, and an absorbance of less than about 0.1 at 935 nm;
the toner having an absorbance of about 0.1 to about 0.6 at 450 nm, an absorbance of less than about 0.2 at 550 nm, an absorbance of less than about 0.1 at 650 nm, and an absorbance of greater than about 0.1 at 935 nm;
further wherein the toner-substrate absorbance difference is about 0.2 or less at 450 nm, at 550 nm, and at 650 nm, and about 0.1 or greater at 935 nm.

15. A method for preparing a substrate having a toner situated thereon;
the substrate having an absorbance of about 0.1 to about 0.6 at 450 nm, an absorbance of less than about 0.2 at 550 nm, an absorbance of less than about 0.1 at 650 nm, and an absorbance of less than about 0.1 at 935 nm; and
the toner having an absorbance of about 0.1 to about 0.6 at 450 nm, an absorbance of less than about 0.2 at 550 nm, an absorbance of less than about 0.1 at 650 nm, and an absorbance of greater than about 0.1 at 935 nm;
the method comprising:
(a) contacting an electrostatic image, with at least one magnetic brush, to develop the electrostatic image, the at least one magnetic brush comprising:
(i) a rotating magnetic core of a preselected magnetic field strength;
(ii) an outer nonmagnetic shell disposed about the rotating magnetic core; and
(iii) an electrographic developer composition disposed on an outer surface of the shell and in contact with the image, the developer composition comprising charged toner particles and oppositely charged hard magnetic carrier particles; and
(b) transferring the resulting toned electrostatic image to the substrate;
the toner of the charged toner particles comprising:
a binder resin; and
an NIR colorant.

16. A substrate having a toner situated thereon, the toner comprising:
(a) a binder resin; and
(b) an NIR colorant;
the toner-substrate absorbance difference being about 0.2 or less at 450 nm, at 550 nm, and at 650 nm, and about 0.1 or greater at 935 nm.
